(19) United States
(12) Patent Application Publication
(10) Pub. No.: US 2014/0239545 A1
(43) Pub. Date: Aug. 28, 2014

(54) MOLD AND METHOD OF MANUFACTURING MESH-INTEGRATED FILTER USING THE SAME

(71) Applicant: HANCHANG ENPLA CO., LTD., Anseong-si Gyeonggi-do (KR)

(72) Inventors: Ji Hyoung Kim, Anseong-si Gyeonggi-do (KR); Sang Dae Park, Suwon-si (KR)

(73) Assignee: HANCHANG ENPLA CO., LTD., Anseong-si, Gyeonggi-do (KR)

(21) Appl. No.: 13/990,166

(22) PCT Filed: Nov. 13, 2012
(86) PCT No.: PCT/KR2012/009554

§ 371 Date: May 29, 2013

(30) Foreign Application Priority Data
Nov. 17, 2011 (KR) 10-2011-0120454

(51) Int. Cl. B29C 33/12; B29C 45/14

(52) U.S. Cl. CPC B29C 33/12; B29C 45/14
USPC 264/257; 425/112

(57) ABSTRACT

Disclosed are a mold and a method of manufacturing a mesh-integrated filter using the same. The mold includes a lower body; a protruding pin provided to the lower body to protrude upward; a plurality of sliders slidably disposed on the lower body to move forward and surrounding a circumference of the protruding pin; an upper body covering upper sides of the sliders and having an injection hole formed therethrough such that a liquid resin is injected into a gap between the protruding pin and the sliders through the injection hole; and a shaping portion for forming a mesh-integrated filter upon hardening of the liquid resin. The mold can form a mesh-integrated filter in a closed state to improve productivity by eliminating a separate process for assembling a mesh and a filter.

### TECHNICAL FIELD

The present invention relates to a mesh-integrated filter, and more particularly, to a mold which can form a mesh-integrated filter in a closed state and can improve productivity by eliminating a separate process for assembling a mesh and a filter, and a method of manufacturing a mesh-integrated filter using the same.

### BACKGROUND ART

A general anti-lock brake system (ABS) for vehicles detects wheel slip to control braking pressure applied to the wheels, thereby preventing the wheels from locking up during braking operation.

Through the anti-lock brake system, braking operation can be safely performed by preventing wheel slip while maintaining directionality during the braking operation. The brake system includes a plurality of solenoid valves which open and close oil passages of brake oil pressure lines to control braking pressure. The solenoid valves include normally open solenoid valves which are normally kept in an open state and normally closed solenoid valves which are normally kept in a closed state.

The solenoid valve is press-fitted into a bore of a modulator block and includes a hollow valve housing having an entrance and an exit for flow of fluid. A cylindrical sleeve is coupled to one end of the valve housing such that an armature placed in the valve housing can move forward and rearward, and a valve core for advancing and retracting the armature while closing an open portion of the sleeve is coupled to an open end of the sleeve. The armature opens and closes an orifice of a valve sheet through forward and rearward movement thereof. To this end, the armature includes a shut-off portion extending toward the valve sheet through the hollow portion of the valve housing.

A filter assembly having a filter is placed at an outer side of the valve housing.

A solenoid valve having a filter assembly is disclosed in Korean Patent No. 10-1009266 (entitled “Solenoid Valve”).

### DISCLOSURE

### Technical Problem

A filter assembly for solenoid valves in the related art is manufactured by injection-molding a target product surrounding a portion of a mesh to assemble the target product to the mesh, causing inconvenience and difficulty in assembly and assembly defects. Accordingly, there is a need to solve this problem.

It is an aspect of the present invention to provide a mold which can form a mesh-integrated filter in a closed state and can improve productivity by eliminating a separate process for assembling a mesh and a filter, and a method of manufacturing a mesh-integrated filter using the same.

### TECHNICAL SOLUTION

In accordance with one aspect of the present invention, a mold includes: a lower body; a protruding pin provided to the lower body to protrude upward; a plurality of sliders slidably disposed on the lower body to move forward and surrounding a circumference of the protruding pin; an upper body covering upper sides of the sliders and having an injection hole formed therethrough such that a liquid resin is injected into a gap between the protruding pin and the sliders through the injection hole; and a shaping portion for forming a mesh-integrated filter upon hardening of the liquid resin.

The shaping portion may include: longitudinal strips protruding parallel to each other from a circumferential surface of the protruding pin in an axial direction of the protruding pin; and transverse strips protruding from an inner surface of each of the sliders such that the transverse strips are inclined with respect to the longitudinal strips and are brought into contact with the longitudinal strips.

Each of the sliders may define spaces in a circumferential direction of the protruding pin such that reinforcing ribs are formed to reinforce the mesh-integrated filter in an axial direction thereof.

The transverse strips may be discontinuously formed in the circumferential direction of the protruding pin to secure fluidity of the liquid resin.

Each of the transverse strips may have rounded portions at opposite sides thereof.

Each of the sliders may include a plurality of slide plates stacked one above another and fixed to arrange a plurality of transverse strips.

The protruding pin may have a frustoconical shape, an outer diameter of which is gradually decreased from a lower side to an upper side thereof.

The protruding pin may be provided to the lower body to be movable upward and downward.

In accordance with another aspect of the present invention, a method of manufacturing a mesh-integrated filter using the mold as set forth above includes: moving sliders of the mold forward to surround the protruding pin protruding upward from the lower body of the mold; lowering an upper body of the mold to contact the protruding pin and upper sides of the sliders; pouring the liquid resin though the injection hole formed through the upper body of the mold to fill a gap between the protruding pin and the sliders with the liquid resin; and forming the mesh-integrated filter with longitudinal strips of the protruding pin and transverse strips of the sliders contacting each other by hardening the liquid resin.

The method may further include: moving the upper body and the sliders, after producing the mesh-integrated filter; and lowering the protruding pin toward a lower side of the lower body to separate the mesh-integrated filter from the protruding pin.

### ADVANTAGEOUS EFFECTS

As described above, the mold and the method of manufacturing a mesh-integrated filter using the same according to the present invention can form a mesh-integrated filter in a closed state and can improve productivity by eliminating a separate process for assembling a mesh and a filter.

### DESCRIPTION OF DRAWINGS

FIG. 1 is a perspective view of a mesh-integrated filter according to one embodiment of the present invention.

FIG. 2 is a cut-away perspective view of the mesh-integrated filter according to the embodiment of the present invention.

FIG. 3 is a perspective view of a mold for manufacturing a mesh-integrated filter according to one embodiment of the present invention.

FIG. 4 is an exploded perspective view of the mold for manufacturing a mesh-integrated filter according to the embodiment of the present invention.

FIG. 5 is a longitudinal sectional view of the mold for manufacturing a mesh-integrated filter according to the embodiment of the present invention.

FIG. 6 is an enlarged view of a protruding pin and sliders having strips in the mold for manufacturing a mesh-integrated filter according to the embodiment of the present invention.

FIG. 7 is a plan view of the protruding pin and the sliders having the strips in the mold for manufacturing a mesh-integrated filter in a closed state, according to the embodiment of the present invention.

FIG. 8 is a perspective view of sliders of a mold for manufacturing a mesh-integrated filter according to another embodiment of the present invention.

FIG. 9 is a sectional view of the sliders of FIG. 8.

FIG. 10 is a perspective view of sliders of a mold for manufacturing a mesh-integrated filter according to a further embodiment of the present invention.

FIG. 11 is a sectional view of the sliders of FIG. 10.

FIG. 12 is a view of another embodiment of a slider according to the present invention.

FIG. 13 is an exploded perspective view of the sliders of FIG. 12.

FIG. 14 is a front view of a protruding pin of a mold for manufacturing a mesh-integrated filter according to one embodiment of the present invention.

FIG. 15 is a flowchart of a method of manufacturing a mesh-integrated filter according to one embodiment of the present invention.

### BEST MODE

Hereinafter, embodiments of the invention will be described with reference to the accompanying drawings. It should be noted that the drawings are not to precise scale and may be exaggerated in thickness of lines or size of components for descriptive convenience and clarity alone. Furthermore, the terms used herein are defined by taking functions of the present disclosure into account and can be changed according to user or operator's custom or intention. Therefore, definition of the terms should be made according to the overall disclosure set forth herein.

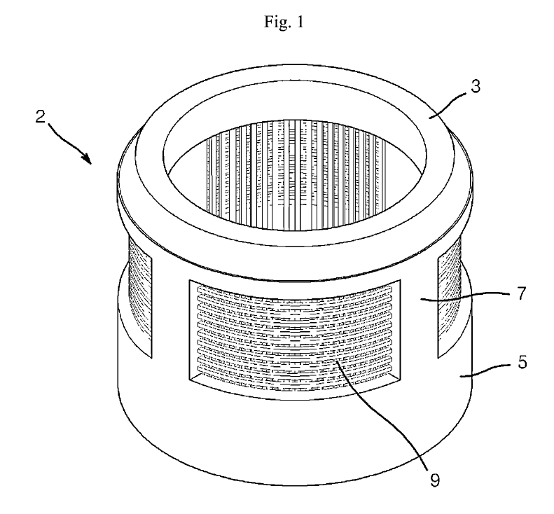

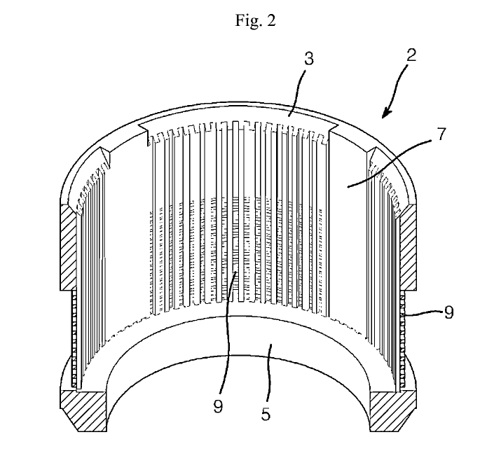

FIG. 1 is a perspective view of a mesh-integrated filter according to one embodiment of the present invention, and FIG. 2 is a cut-away perspective view of the mesh-integrated filter according to the embodiment of the present invention.

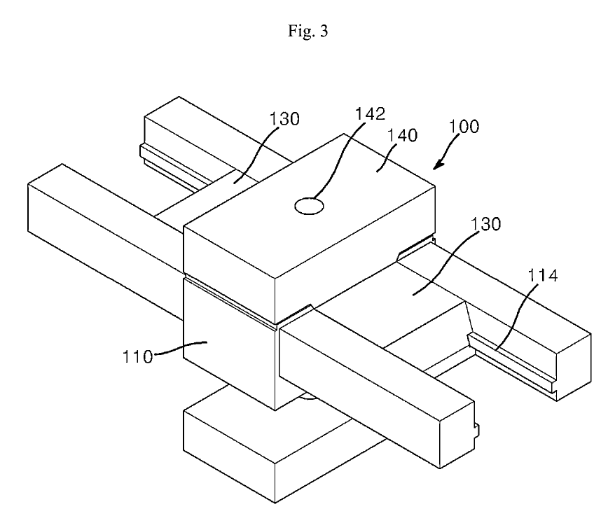

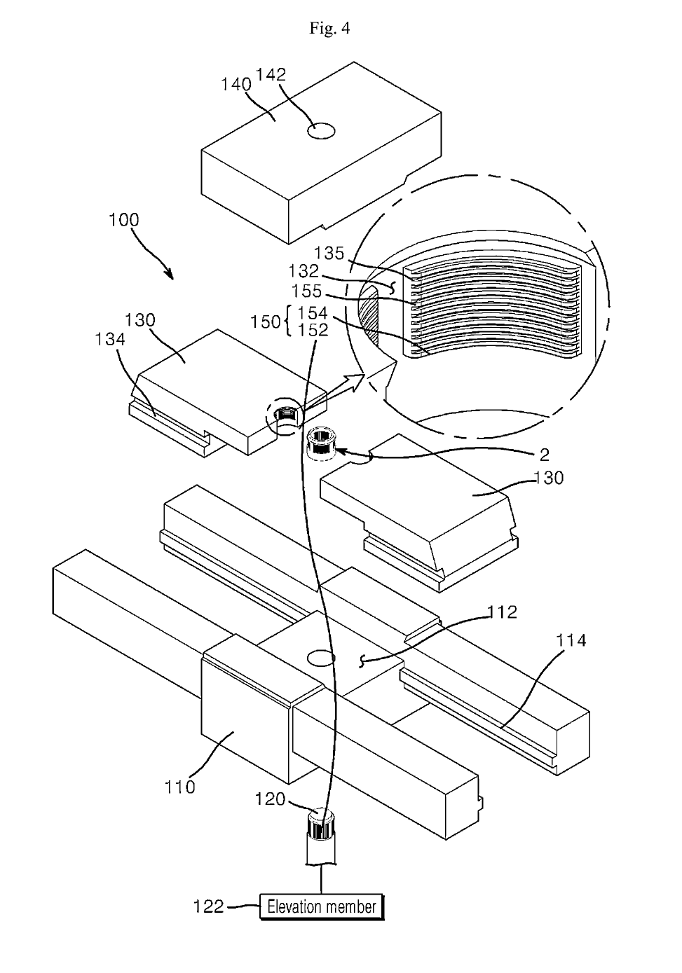

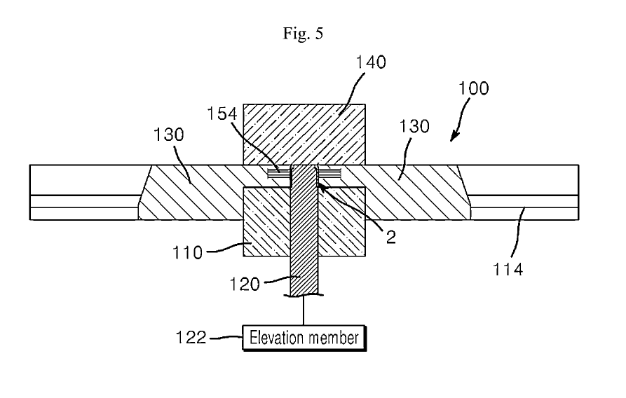

FIG. 3 is a perspective view of a mold for manufacturing a mesh-integrated filter according to one embodiment of the present invention, FIG. 4 is an exploded perspective view of the mold for manufacturing a mesh-integrated filter according to the embodiment of the present invention, and FIG. 5 is a longitudinal sectional view of the mold for manufacturing a mesh-integrated filter according to the embodiment of the present invention.

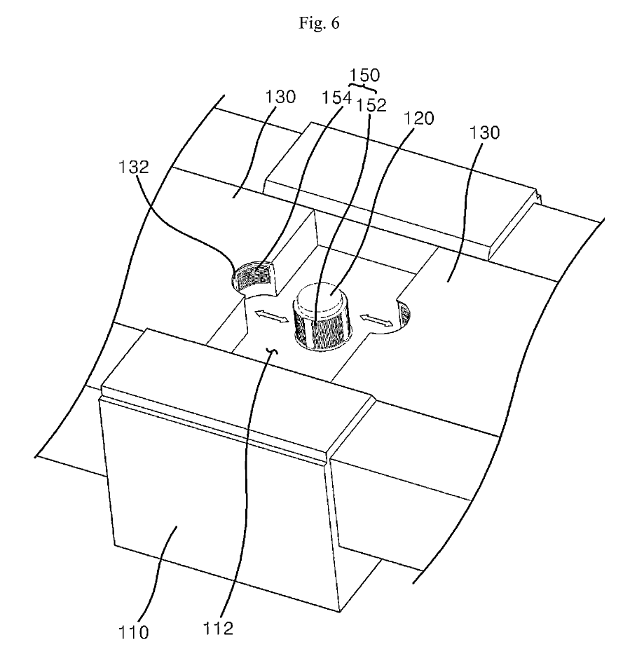

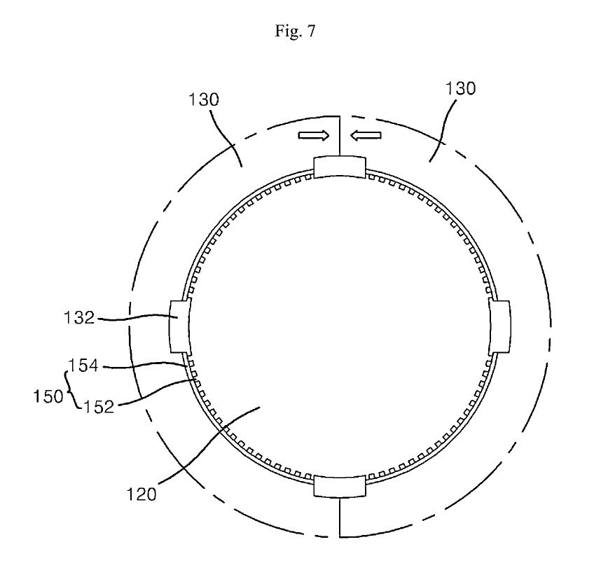

FIG. 6 is an enlarged view of a protruding pin and sliders having strips in the mold for manufacturing a mesh-integrated filter according to the embodiment of the present invention, and FIG. 7 is a plan view of the protruding pin and the sliders having the strips in the mold for manufacturing a mesh-integrated filter in a closed state, according to the embodiment of the present invention.

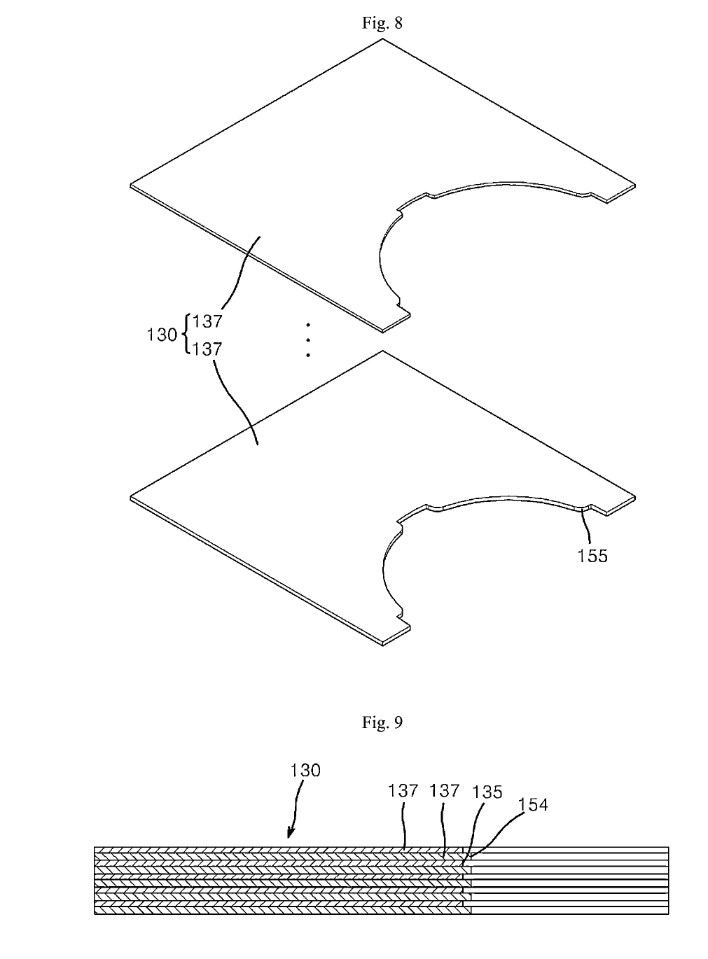

FIG. 8 is a perspective view of sliders of a mold for manufacturing a mesh-integrated filter according to another embodiment of the present invention, and FIG. 9 is a sectional view of the sliders of FIG. 8.

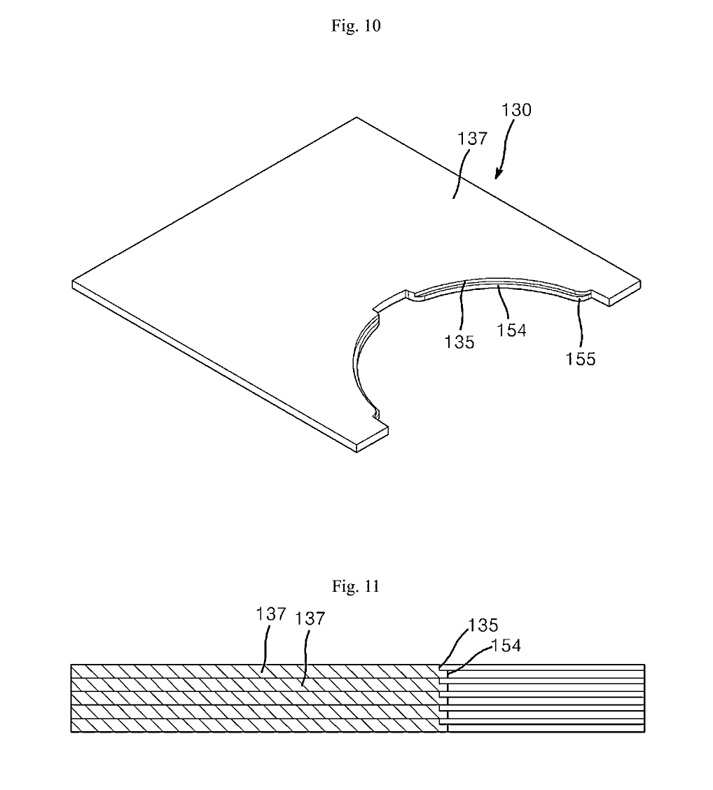

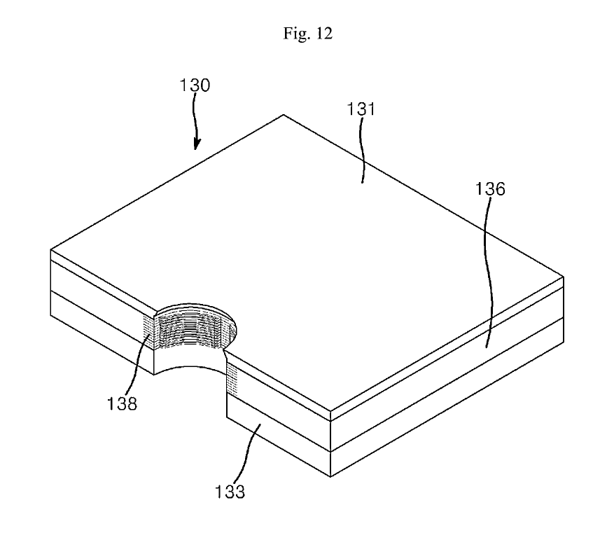

FIG. 10 is a perspective view of sliders of a mold for manufacturing a mesh-integrated filter according to a further embodiment of the present invention, and FIG. 11 is a sectional view of the sliders of FIG. 10.

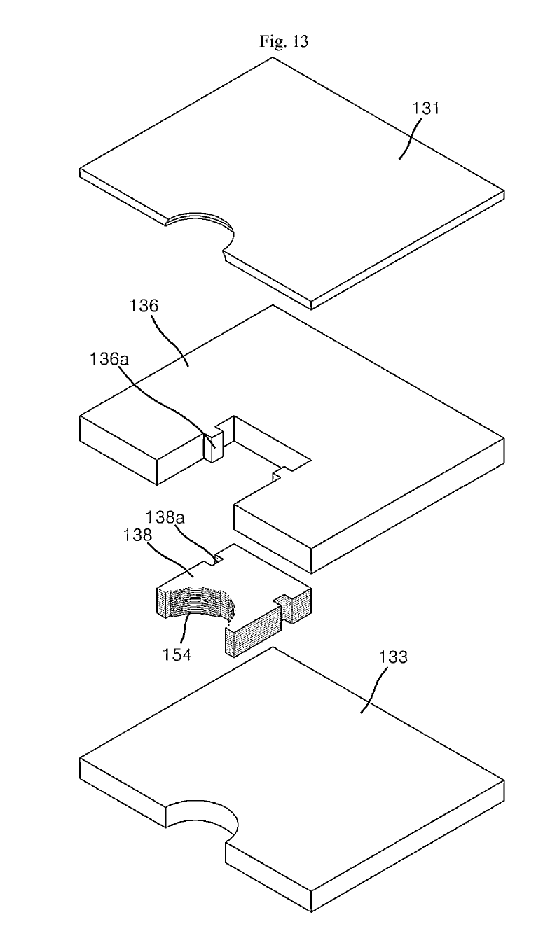

FIG. 12 is a view of another embodiment of a slider according to the present invention, and FIG. 13 is an exploded perspective view of the sliders of FIG. 12.

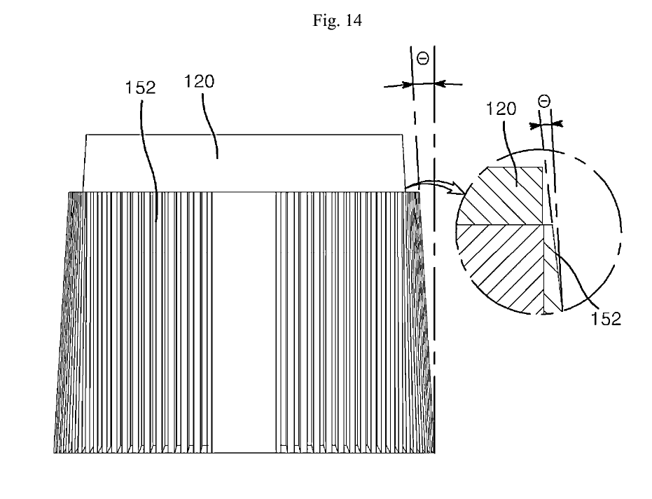

FIG. 14 is a front view of a protruding pin of a mold for manufacturing a mesh-integrated filter according to one embodiment of the present invention.

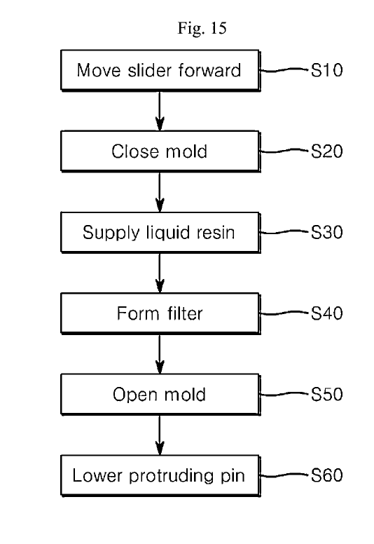

FIG. 15 is a flowchart of a method of manufacturing a mesh-integrated filter according to one embodiment of the present invention

Referring to FIGS. 3, 4, and 5, a mold for manufacturing a mesh-integrated filter 2 according to one embodiment of the invention includes a lower body 110, a protruding pin 120, sliders 130, an upper body 140, and a shaping portion 150.

In particular, the mesh-integrated filter 2 is applied to a filter assembly of a solenoid valve for a braking system, and serves to filter a working fluid. In addition, the mesh-integrated filter 2 may be applied to systems for various operations, such as electronic stability program (ESP), vehicle dynamic control (VDC), dynamic stability control (DSC), vehicle skid control (VSC), and electronic stability control (ESC).

As shown in FIGS. 1 and 2, the mesh-integrated filter 2 has a circular or polygonal tubular shape, and includes an upper rim 3, a lower rim 5, reinforcing ribs 7 which connect the upper rim 3 to the lower rim 5, and a mesh 9 formed between reinforcing ribs 7. The upper rim 3, the lower rim 5, and the reinforcing ribs 7 serve to strengthen the mesh-integrated filter 2 or to maintain the shape of the mesh-integrated filter 2, and the mesh 9 serves to filter a working fluid. The mesh 9 has a net shape.

The lower body 110 is placed at a lower side of the mold 100 and supports the sliders 130 and the upper body 140.

The protruding pin 120 is provided to the lower body 110 to protrude upward. The protruding pin 120 serves to form an inner shape of the formed mesh-integrated filter 2, and is formed to have a circular or polygonal column shape that conforms with a desired inner shape of the mesh-integrated filter 2.

A plurality of sliders 130 is slidably disposed on the lower body 110 to move forward, and surrounds the circumference of the protruding pin 120. The sliders 130 serve to form an outer shape of the mesh-integrated filter 2 in the course of molding, and have inner surfaces corresponding to a desired outer shape of the mesh-integrated filter 2. For convenience, each of the inner surfaces of the sliders 130 is shown as having a concave arc shape. Although two sliders 130 are shown in this embodiment, the present invention is not limited thereto.

The sliders 130 are moved forward and rearward by a cylinder or the like.

In particular, it is noted that the sliders 130 are placed on the lower body 110 to stably linearly move forward or rearward. This configuration prevents defect in the mesh-integrated filter 2 after molding.

Thus, the protruding pin 120 is secured in position in the lower body 110.

The sliders 130 are connected to the lower body 110 to be linearly moved forward and rearward. For example, the lower body 110 has a positioning recess 112 on which the sliders 130 can be seated, and guide bosses 114 protruding from inner surfaces thereof facing each other. A guide groove 134, which engages with the guide boss 114, is formed in each of the sliders 130 to enable linear reciprocation of the sliders 130 along the guide bosses 114.

In particular, the lower body 110 may include a separate stopper (not shown), which stops further movement of the sliders 130 inside the positioning recess 112 when the sliders 130 are finally moved forward or rearward.

With the sliders 130 surrounding the circumference of the protruding pin 120, the upper body 140 covers upper sides of the sliders 130 and the protruding pin 120, and an injection hole 142 is formed through the upper body 140 to allow a liquid resin to be injected into a gap between the protruding pin 120 and the sliders 130 therethrough.

The upper body 140 can be moved upward or downward by various linear actuators such as a cylinder. The upper body 140 is formed with the injection hole 142 through which the liquid resin is injected into the gap between the protruding pin 120 and the sliders 130. Here, it should be understood that the present invention is not limited to a specific position and number of injection holes 142. Of course, the injection hole 142 may be provided in an opened or closed form.

In addition, it is desirable that the mesh-integrated filter 2 be naturally formed by hardening the liquid resin after injecting the liquid resin into the gap between the protruding pin 120 and the sliders 130, with the sliders 130 surrounding the circumference of the protruding pin 120. In particular, it is desirable that the mesh 9 of the mesh-integrated filter 2 be naturally formed through hardening of the liquid resin.

Thus, the shaping portion 150 is provided to naturally form the mesh-integrated filter 2 upon hardening of the liquid resin.

As shown in FIGS. 6 and 7, the shaping portion 150 includes longitudinal strips 152 and transverse strips 152.

The longitudinal strips 152 protrude from a circumferential surface of the protruding pin 120 in an axial direction of the protruding pin 120 and are arranged parallel to each other. That is, the longitudinal strips 152 have an undulating shape circumferentially formed on the circumferential surface of the protruding pin 120. In particular, the longitudinal strips 152 are integrally formed with the circumferential surface of the protruding pin 120. Of course, the number of longitudinal strips 152, that is, a pitch between the longitudinal strips 152, is not particularly limited.

In addition, the transverse strips 154 protrude from an inner surface of each of the sliders 130 facing the protruding pin 120. In particular, the transverse strips 154 are inclined with respect to the longitudinal strips 152 and arranged parallel to each other. When the sliders 130 are completely moved forward from the lower body 110 toward the protruding pin 120, the longitudinal strips 152 contact the transverse strips 154. Thus, the mesh 9 can be naturally formed as the liquid resin is hardened at a contact portion between the longitudinal strips 152 and the transverse strips 154 after the gap between the sliders 130 and the protruding pin 120 is filled with the liquid resin.

For convenience, the longitudinal strips 152 and the transverse strips 154 are shown arranged perpendicular to each other. Of course, the number of transverse strips 154, that is, a pitch between the transverse strips 154, is not particularly limited.

It is desirable that the reinforcing ribs 7 of the mesh-integrated filter 2 be naturally formed by hardening the liquid resin after injecting the liquid resin into the gap between the protruding pin 120 and the sliders 130 while the sliders 130 surround the circumference of the protruding pin 120.

Thus, the sliders 130 define spaces 132 in a circumferential direction of the protruding pin 120. As a result, the reinforcing ribs 7 can be naturally formed as the liquid resin is hardened after the spaces 132 are filled with the liquid resin.

Consequentially, each of the sliders 130 is discontinuously formed with the transverse strips 154 in the circumferential direction of the protruding pin 120. This configuration achieves natural formation of the reinforcing ribs 7 of the mesh-integrated filter 2 while securing fluidity of the liquid resin. That is, the liquid resin discontinuously forms the transverse strips 154 and thus can flow into the gap between the sliders 130 and the protruding pin 120 through the spaces 132 defined between the transverse strips 154, whereby the mesh 9 can be formed as the liquid resin is hardened after the liquid resin flows to the contact portion between the longitudinal strips 152 and the transverse strips 154.

The transverse strips 154 have rounded portions 155 at opposite sides thereof. This secures a flow passage of the liquid resin injected into the gap between the sliders 130 and the protruding pin 120, with edges of the plurality of sliders 130 contacting each other.

When the liquid resin is injected into and hardened in the gap between the sliders 130 and the protruding pin 120 in a closed state of the mold, the mesh-integrated filter 2 is formed.

Here, the closed state of the mold refers to a state in which the sliders 130 are moved forward while the transverse strips 154 of each of the sliders 130 and the longitudinal strips 152 of the protruding pin 120 contact each other, and the upper body 140 covers the sliders 130 and the protruding pin 120.

Then, the mesh-integrated filter 2 is exposed when the mold is open. Here, the open state of the mold refers to a state in which the upper body 140 is raised and the sliders 130 are moved rearward.

In particular, the mesh-integrated filter 2 is stacked on the protruding pin 120. Thus, when an operator pulls and raises the mesh-integrated filter 2, the mesh-integrated filter 2 can be damaged.

Thus, the protruding pin 120 is preferably provided to the lower body 110 so as to be moved upward or downward. That is, when the protruding pin 120 is lowered toward a lower side of the lower body 110 in an open state of the mold, the mesh-integrated filter 2 is placed on an upper side of the lower body 110.

Here, the protruding pin 120 may be elevated by an elevation member 122 such as a cylinder. In addition, the protruding pin 120 may be integrally formed with the elevation member 122, or may be detachably coupled to the elevation member 122 in various ways.

Since each of the sliders 130 is formed on the inner surface thereof with the transverse strips 154 to be separated from each other by constant intervals, a groove 135 is formed between the transverse strips 154. Each of the sliders 130 may be constituted by a single block, or by a plurality of blocks stacked one above another.

As shown in FIGS. 8 and 9, in another embodiment, each of the sliders 130 is constituted by a plurality of slide plates 137 which are stacked one above another to arrange a plurality of transverse strips 154.

In particular, when the plurality of slide plates 137 is stacked one above another, the slide plates 137 are disposed to protrude alternately toward the protruding pin 120 in the longitudinal direction so as to sequentially form the transverse strips 154 and the grooves 135.

Although not shown in the drawings, the slide plates 137 may be fastened to each other in a stacked state in various ways, such as bolting and the like.

In addition, as shown in FIGS. 10 and 11, in a further embodiment, each of the sliders 130 is constituted by a plurality of slide plates 137 which are stacked one above another to arrange a plurality of transverse strips 154.

In particular, each of the slide plates 137 includes one transverse strip 154 and one recess 135 such that transverse strips 154 and grooves 135 are sequentially formed when a plurality of slide plates 137 are stacked one above another. Thus, the transverse strips 154 and the grooves 135 are sequentially disposed longitudinally when the slide plates 137 are stacked one above another.

Although not shown in the drawings, the slide plates 137 may be fastened to each other in a stacked state in various ways, such as bolting and the like.

The slide plates 137 are depressed at certain portions thereof to form the spaces 132 when the slide plates 137 are stacked to form the slider 130.

Of course, each of the transverse strips 154 of the slide plates 137 is formed at opposite sides thereof with the rounded portions 155.

As shown in FIGS. 12 and 13, in yet another embodiment, each of the sliders 130 includes an upper plate 131, a lower plate 133, a holder 136, and a processing tool 138.

The upper plate 131 and the lower plate 133 surface-contact the corresponding upper and lower sides of the holder 136 and the processing tool 138 to maintain a stacked state. That is, although not shown in the drawings, the upper plate 131, the holder 136, and the lower plate 133 are fastened to one another by bolting or the like.

In addition, the holder 136 serves to hold the processing tool 138 inserted into the holder 136, and the processing tool 138 is formed at a front side thereof with transverse strips 154. Here, since the transverse strips 154 are formed on the front side of the processing tool 138, the front side of the processing tool 138 is concavely formed, and thus portions of the upper plate 131 and the lower plate 133 corresponding to the processing tool 138 are also concavely formed.

In particular, the holder 136 is formed with insertion bosses 136a protruding from inner sides of the holder 136 facing each other, and the processing tool 138 is formed with insertion recesses 138a corresponding to the insertion bosses 136a. Thus, the processing tool 138 is detachably mounted to the holder 136. Accordingly, the processing tool 138 may be easily replaced when damaged or worn.

As shown in FIG. 14, the protruding pin 120 has a frustoconical shape, the outer diameter of which is gradually increased from an upper side to a lower side.

Specifically, the protruding pin 120 is inclined by a predetermined angle (A) with respect to a vertical line from the lower side towards the upper side, so that the sectional area of the protruding pin gradually decreases toward the upper side thereof. This configuration allows easy separation of the mesh-integrated filter 2 from the protruding pin 120 as the protruding pin is lowered.

The protruding pin 120 and the longitudinal strips 152 may be subjected to plating to prevent rust, to improve strength and to allow easy separation from the mesh-integrated filter 2. In particular, the protruding pin 120 and the longitudinal strips 152 may be plated with various metals, such as chromium and titanium.

In addition, the longitudinal strips 152 are inclined by a predetermined angle 0 with respect to a surface of the protruding pin 120. That is, each of the longitudinal strips 152 is inclined by a predetermined angle 0 with respect to the surface of the protruding pin 120 from a lower side to an upper side such that the protruding pin 120 has a frusto-conical shape, the outer diameter of which is gradually decreased from the lower side to the upper side thereof.

More specifically, the protruding pin 120 may be originally formed in a frusto-conical shape, or otherwise each of the longitudinal strips 152 may be formed to have a thin upper side and a thick lower side on the protruding pin 120 having a cylindrical shape.

Referring to FIG. 15, a method of manufacturing a mesh-integrated filter 2 according to one embodiment includes: moving the sliders forward (S10), closing the mold (S20), supplying a liquid resin (S30), forming a filter (S40), opening the mold (S50), and lowering the protruding pin (S60).

Operation of moving the sliders forward (S10) is a process of moving the sliders 130 forward to surround the protruding pin 120 protruding upward from the lower body 110. The sliders 130 are moved toward the protruding pin 120 in the forward direction by a cylinder. Then, the sliders 130 are stopped, when the transverse strips 154 contact the longitudinal strips 152 of the protruding pin 120 or are moved a predetermined distance in the forward direction.

Operation of closing the mold (S20) is a process of lowering the upper body 140 such that the upper body 140 contacts the protruding pin 120 and the upper sides of the sliders 130.

Here, the upper body 140 is lowered by a cylinder.

Operation of supplying a liquid resin (S30) is a process of injecting the liquid resin though the injection hole 142 formed though the upper body 140 such that a gap between the protruding pin 120 and the sliders 130 is filled with the liquid resin.

Operation of forming a filter (S40) is a process of hardening the liquid resin filling the gap between the protruding pin 120 and the sliders 130 such that the mesh-integrated filter 2 is naturally formed by the longitudinal strips 152 of the protruding pin 120 and the transverse strips 154 of the sliders 130, which contact each other.

Of course, the mesh-integrated filter 2 is naturally formed with an upper rim 3, a lower rim 5, and reinforcing ribs 7 through hardening of the liquid resin filling the gap between the protruding pin 120 and the sliders 130 to support and reinforce a mesh 9 formed by the longitudinal strips 152 and the transverse strips 154.

In addition, operation of opening the mold (S50) is a process of moving the upper body 140 and the sliders 130 in a direction opposite to the movement direction of the upper body 140 and the sliders 130 when the mold is closed. Then, the upper body 140 and the sliders 130 are moved when the liquid resin is completely hardened and the mesh-integrated filter 2 is formed. Thus, the mesh-integrated filter 2 is exposed on an upper side of the lower body 110 while being covered by the protruding pin 120.

Operation of lowering the protruding pin (S60) is a process of lowering the protruding pin 120 toward a lower side of the lower body 110 and separating the mesh-integrated filter 2 from the protruding pin 120.

Here, since the protruding pin 120 and the longitudinal strips 152 are plated with chromium, the protruding pin 120 and the longitudinal strips 152 can be easily separated from the mesh-integrated filter 2. Thus, the mesh-integrated filter 2 can be prevented from defects since the mesh-integrated filter 2 is kept in a formed state.

Although some embodiments have been described with reference to the accompanying drawings and tables, it should be understood that the present invention is not limited to these embodiments and can be made in various different ways, and that various modifications, variations, and alterations can be made by those skilled in the art without departing from the spirit and scope of the present invention. Therefore, the scope of the present invention should be determined by the claims and equivalents thereof.

1. A mold comprising:
a lower body;
a protruding pin provided to the lower body to protrude upward;
a plurality of sliders slidably disposed on the lower body to move forward and surrounding a circumference of the protruding pin;
an upper body covering upper sides of the sliders and having an injection hole formed therethrough such that a liquid resin is injected into a gap between the protruding pin and the sliders through the injection hole; and
a shaping portion for forming a mesh-integrated filter upon hardening of the liquid resin.

2. The mold according to claim 1, wherein the shaping portion comprises longitudinal strips protruding parallel to each other from a circumferential surface of the protruding pin in an axial direction of the protruding pin; and transverse strips protruding from an inner surface of each of the sliders such that the transverse strips are inclined with respect to the longitudinal strips and are brought into contact with the longitudinal strips.

3. The mold according to claim 2, wherein each of the sliders defines spaces in a circumferential direction of the protruding pin such that reinforcing ribs are formed to reinforce the mesh-integrated filter in an axial direction thereof.

4. The mold according to claim 2, wherein the transverse strips are discontinuously formed in the circumferential direction of the protruding pin to secure fluidity of the liquid resin.

5. The mold according to claim 2, wherein each of the transverse strips has rounded portions at opposite sides thereof.

6. The mold according to claim 2, wherein each of the sliders comprises a plurality of slide plates stacked one above another and fixed to arrange a plurality of transverse strips.

7. The mold according to claim 1, wherein the protruding pin has an outer shape, a width of which is gradually increased from an upper side to a lower side.

8. The mold according to claim 1, wherein the protruding pin is provided to the lower body to be moved upward and downward.

9. A method of manufacturing a mesh-integrated filter, comprising:
moving sliders of a mold forward to surround a protruding pin protruding upward from a lower body of the mold;
lowering an upper body of the mold to contact the protruding pin and upper sides of the sliders;
pouring a liquid resin though an injection hole formed through the upper body of the mold to fill a gap between the protruding pin and the sliders with the liquid resin; and
forming a mesh-integrated filter with longitudinal strips of the protruding pin and transverse strips of the sliders contacting each other by hardening the liquid resin.

10. The method according to claim 9, further comprising:
moving the upper body and the sliders, after producing the mesh-integrated filter; and
lowering the protruding pin toward a lower side of the lower body to separate the mesh-integrated filter from the protruding pin.
